(19) United States
(12) Patent Application Publication
(10) Pub. No.: US 2025/0005492 A1
(43) Pub. Date: Jan. 2, 2025

(54) ANOMALY RECOGNITION METHOD AND SYSTEM FOR TRACKS OF TRUCKS

(71) Applicants: Tianjin University, Tianjin (CN); Beijing Fantastic Technology Co. Ltd, Beijing (CN)

(72) Inventors: Ning JIA, Tianjin (CN); Liao CHEN, Tianjin (CN); Runbang CUI, Tianjin (CN); Wei WEI, Tianjin (CN); Miao YANG, Tianjin (CN); Lingxiao YANG, Tianjin (CN)

(21) Appl. No.: 18/740,534

(22) Filed: Jun. 12, 2024

(30) Foreign Application Priority Data
Jun. 27, 2023 (CN) 2023107632957

(51) Int. Cl. G06Q 10/0635; G06N 3/0499

(52) U.S. Cl. CPC G06Q 10/0635; G06N 3/042; G06N 3/045; G06N 3/0499

(57) ABSTRACT

Disclosed in the present application are an anomaly recognition method and an anomaly recognition system for tracks of trucks. The method includes: obtaining a running track T according to global positioning system (GPS) data of running of a truck to be recognized; employing a track compression algorithm for the running track T to obtain a compressed track set C; employing a density-based clustering algorithm and performing grouping according to set time periods to obtain a network graph representing a motion track of each time period; inputting the network graph into a track embedding model established and trained in advance to obtain an explicit embedding vector corresponding to each network graph; and determining stability according to a distance between the vectors, and classifying points with the stability lower than a set threshold as abnormal tracks. The track embedding model is realized by employing a Skipgram model on the basis of a graph2vec algorithm.

### TECHNICAL FIELD

The present application relates to the technical field of anomaly recognition of tracks, and in particular to an anomaly recognition method and an anomaly recognition system for tracks of trucks, which are used for loan-oriented risk management.

### BACKGROUND

With development of global positioning, cloud computing and other technologies, a large amount of track data with spatiotemporal location information can be collected, stored and calculated, such that anomaly detection based on big track data has become a hot issue, and some scholars at home and abroad have carried out certain research. Traditional track anomaly detection methods include outlier detection based on distances between objects and anomaly detection based on similarity calculation of historical tracks. Traditional anomaly detection techniques often ignore features of time dimensions of tracks, which is difficult to dynamically evaluate users' abnormal behavior in post-loan monitoring. With development of machine learning, there are some abnormal track recognition methods based on classification or clustering algorithms, which still can't consider the spatiotemporal correlation of tracks. Moreover, these methods depend on feature engineering to a great extent, which have high requirements on expert experience or experiments.

A global positioning system (GPS) pre-mounted on a truck can collect information such as latitude and longitude coordinates, time stamps, instantaneous speeds and directions of the truck at certain time intervals. A large number of interrelated track points constitute a vehicle track sequence. How to mine track features from such multi-dimensional spatiotemporal sequences and express same in the form of structured data is the key problem to recognize abnormal tracks.

In addition, the GPS track of the truck often has the characteristics of a wide moving range, skewness distribution, a large data scale and a fast update. Different from private cars or taxis, trucks tend to move around the country, and existing models struggle to represent a nationwide high-density track map by means of a network model. Moreover, the moving tracks of the trucks usually have the skewed distribution features such as periodic and uneven distribution. Commercial vehicles also have the features of long-term operation, which leads to a large data scale and a fast update speed, which puts forward high requirements for space complexity and time complexity of an algorithm.

### SUMMARY

In view of this, the present application puts forward an anomaly recognition method and an anomaly recognition system for tracks of trucks, so as to adapt to the complexity requirements of a large data size and a fast update speed and improve universality of the method.

According to one aspect of the present application, an anomaly recognition method for tracks of trucks is provided. The method includes:
step S1) obtaining a running track T according to global positioning system (GPS) data of running of a truck to be recognized;
step S2) employing a track compression algorithm for the running track T to obtain a compressed track set C;
step S3) employing a density-based clustering algorithm and performing grouping according to set time periods to obtain a network graph G representing a motion track of each time period;
step S4) inputting the network graph G into a track embedding model established and trained in advance to obtain an explicit embedding vector corresponding to each network graph;
and

step S5) determining stability according to a distance between the vectors, and classifying points with the stability lower than a set threshold as abnormal tracks.

The track embedding model is realized by employing a Skipgram model on the basis of a graph2vec algorithm.

Optionally, the running track T in the step S1) satisfies the following formula:

$$\begin{matrix}T = [ {P}_{1} , {P}_{2} , … , {P}_{n} , … , {P}_{N} ] \\ {P}_{n} = [ {x}_{n} , {y}_{n} , {t}_{n} , {v}_{n} ]\end{matrix}$$

In the formulas, N represents the total number of points of the motion track, and Pₙ represents data of the nth point, which includes four dimensions xₙ, yₙ, tₙ, vₙ, namely longitude, latitude, time and an instantaneous speed respectively.

Optionally, the step S2) specifically includes:
step S2-1) setting a distance threshold D and a compressed track set C, adding two endpoints P₁ and Pₙ of the track into the set C, and setting a line segment x=P₁Pₙ;
step S2-2) traversing all points between two endpoints of the line segment x to find the point Pₙ farthest from the line segment x and the corresponding maximum distance d, if d> D, adding P_{c} into the set C; otherwise, stopping the cycle, and outputting the compressed track set C; and
step S2-3) dividing the original track into two sections by point P_{c}, obtaining two sub-tracks P₁P_{c} and P_{c} Pₙ by taking P_{c} as an endpoint, setting P₁P_{c} and P_{c}Pₙ as the line segment x successively, and going to step S2-2) respectively until the maximum distance d in all sub-tracks is less than the distance threshold D to obtain a compressed track set C=[P₁, P₂, . . . , Pₘ> . . . , P_{M}], where Pₘ represents the mth sampling point, and M represents the total number of sampling points after track compression.

Optionally, the step S3) specifically includes:
step S3-1) setting k as the minimum number of points in a neighborhood and r as a neighborhood radius;
step S3-2) randomly selecting a point Pₘ in the track set C, if other points exist in the neighborhood radius r of Pₘ and the number is greater than k−1, creating a new group A and classifying Pₘ into the group, otherwise classifying Pₘ as a noise point, and going to the step S3-2) to reselect points;
step S3-3) traversing all points in the neighborhood of Pₘ, if other points exist in the neighborhood radius r and the number is greater than k−1, classifying same into a new group A, and going to the step S3-3) until no point that satisfies the requirements exists in the neighborhood;
step S3-4) going to the step S3-2) to randomly select points again until all the points in the track set C have groups to which theses points belong or are recognized as noise points; and
step S3-5) classifying all sub-tracks belonging to the same group into a cluster according to the recognized group, denoting the cluster as a node, where a node set is V, a vehicle moves between different sub-tracks, which is recorded into an edge set E of the graph, and the edge is a directed edge; and calculating the degree of the node, thereby forming a network graph G representing the motion track of the corresponding time period.

Optionally, a processing process of the track embedding model in the step S4) specifically includes:
extracting a rooted subgraph of each node from the network graph G, performing vector embedding by using the Skipgram model, and optimizing an output result by using a stochastic gradient descent algorithm.

Optionally, the extracting a rooted subgraph of each node from the network graph G specifically includes:
determining the maximum depth Dh of the rooted subgraph;
finding a neighbor node of a certain node RN from each depth dx from 0 to Dh by employing a breadth-first algorithm, then, searching all subgraphs with the depth of dx−1 for each neighbor node, recording same in the set M_{z}^{(dx)}, and then, finding a subgraph M′ with the node RN as a root node and the depth of dx-1, where the subscript z represents the zth node;
relabeling the subgraphs in M_{z}^{(dx)} by using a Weisfeiler-Lehman algorithm, and then, performing merging with M′ into a subgraph with the depth of dx as an output; and
repeating the above steps until subgraphs of all the nodes are obtained.

Optionally, the Skipgram model includes an input layer, a hidden layer and an output layer, where the output layer is a softmax regression classifier, an input of the Skipgram model is a subgraph of each node of a network graph G, and the output is probability distribution of a subgraph set, so as to obtain an embedding vector of the corresponding network graph G.

Optionally, the step S5) specifically includes:
calculating similarity between the embedding vectors of two adjacent time periods by employing a cosine distance, and calculating an average value of all the cosine distances for quantification to obtain stability of the track; and
classifying points with the stability lower than a set threshold as abnormal tracks.

Optionally, the method further includes a training step of the track embedding model, specifically:
performing training in a negative sampling manner, selecting a training graph G; to be trained, where a subgraph set of Gᵢ is c; performing randomly selection from several groups of graphs adjacent to Gᵢ to form a sample set c′ by selecting root subgraphs of these graphs, such that c′∩c=Ø, and only the sample set c′ is updated in each training; and performing training according to a set learning rate α until training requirements are satisfied, thereby obtaining a trained track embedding model, where Ø represents an empty set.

According to another aspect of the present application, an anomaly recognition system for tracks of trucks is provided. The system includes: a running track obtainment module, a compression module, a clustering algorithm module, a vector output module and an anomaly recognition module.

The running track obtainment module is used for obtaining a running track T according to GPS data of running of a truck to be recognized.

The compression module is used for employing a track compression algorithm for the running track T to obtain a compressed track set C.

The clustering algorithm module is used for employing a density-based clustering algorithm and performing grouping according to set time periods to obtain a network graph G representing a motion track of each time period.

The vector output module is used for inputting the network graph G into a track embedding model established and trained in advance to obtain an explicit embedding vector corresponding to each network graph.

The anomaly recognition module is used for determining stability according to a distance between the vectors, and classifying points with the stability lower than a set threshold as abnormal tracks.

The track embedding model is realized by employing a Skipgram model on the basis of a graph2vec algorithm.

According to the technical solutions of the present application, an anomaly recognition model based on graph representation learning for tracks of trucks is provided. The model can transform a large number of spatiotemporal track sequences into track network graphs, and embed the track network as vectors by means of neural network training, quantify the stability of tracks by means of vector calculation, and recognize abnormal tracks by setting the stability threshold.

According to the technical solutions of the present application, the method has strong robustness to non-uniform and noisy samples, and meanwhile, the network can be simplified by means of track compression and track clustering, such that the operation efficiency of the algorithm is improved.

According to the present application, the complex track network structure is learned into the vector which can be expressed by using structured data, which provides possibility for a subsequent track analysis method.

According to the present application, the spatiotemporal correlation of the track is considered, and the track sequences having periodic features can be better processed.

Experiments are performed on a real commercial truck loan dataset in order to verify effectiveness of the model.

Additional features and advantages of the present application will be described in detail in the following detailed description of embodiments.

### BRIEF DESCRIPTION OF THE DRAWINGS

The accompanying drawings constituting a part of the present application serve to provide a further understanding of the present application, and the illustrative embodiments of the present application and the description thereof serve to interpret the present application. In the accompanying drawings:

FIG. 1 is a flow diagram of an anomaly recognition method for tracks of trucks provided by the present application.

FIG. 2 shows an original track diagram.

FIG. 3 shows a compressed track diagram.

FIG. 4 shows a track diagram after clustering.

FIG. 5A is a visualization track diagram that is determined to be normal, and FIG. 5B is a visualization track diagram that is determined to be abnormal.

### DETAILED DESCRIPTION OF THE EMBODIMENTS

The technical solutions are of an anomaly recognition method based on graph representation learning for tracks.

An objective is to recognize abnormal tracks of trucks. The key problem is to represent the track sequence containing spatiotemporal features as feature vectors, and therefore, a graph2cev algorithm is employed to perform representation learning on the tracks. The idea is to divide the tracks of a user according to a fixed period, represent the track of each period as a vector, calculate the stability according to a distance between the vectors, and classify points with the stability lower than a certain threshold as abnormal tracks.

In order to transform a spatiotemporal track network into a graph structure, points in a track sequence are clustered as nodes of a graph. A clustering method of density-based spatial clustering of applications with noise (DBSCAN) is better for clustering of two-dimensional latitude and longitude coordinates, but the algorithm of DBSCAN has relatively high spatial complexity and is difficult to process massive track data. Therefore, it is necessary to compress the tracks before clustering.

The technical solutions of the present application will be described in detail below with reference to the accompanying drawings and in conjunction with the embodiments.

### Embodiment 1

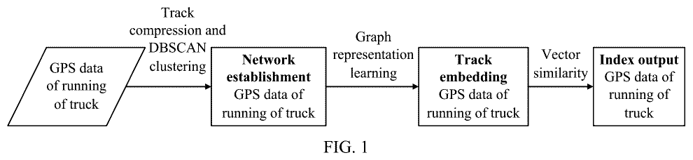

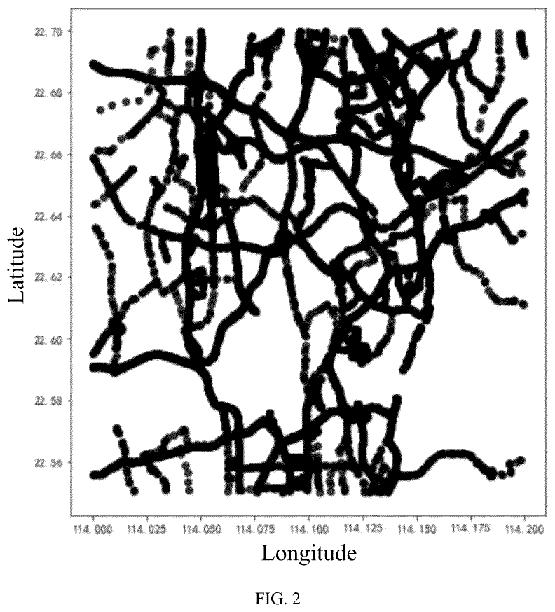

As shown in FIG. 1, an anomaly recognition method for tracks of trucks is proposed in Embodiment 1 of the present disclosure, which includes three parts of establishment of a track network graph, a track embedding model and output of measurement indexes. The specific steps are as follows:
step S1) obtaining a running track T according to global positioning system (GPS) data of running of a truck to be recognized;
step S2) employing a track compression algorithm for the running track T to obtain a compressed track set C;
step S3) employing a density-based clustering algorithm to obtain a network graph G representing a whole motion track;
step S4) inputting the network graph G into a track embedding model established and trained in advance to obtain an explicit embedding vector; and
step S5) determining stability according to a distance between the vectors, and classifying points with the stability lower than a set threshold as abnormal tracks.

### (1) Establishment of Track Network Graph

In order to reduce time complexity of an algorithm, the present application employs a Douglas-Peucker track compression algorithm to reduce a density of tracks and retain key nodes. The algorithm of DBSCAN is employed to classify dense points in the track into a cluster, which makes the model have better anti-interference performance. After clustering, a track network graph of a user is formed according to a time sequence.

Step S1) specifically includes:

An input of the method is vehicle-mounted GPS data, T is employed to represent a spatiotemporal track sequence of a certain user. The total number of points of the track is marked as N, that is Tᵢ=[P₁, P₂, . . . , Pₙ, . . . , P_{N}], where n represents the order in which the point appears in the time sequence, and each point in the sequence has four dimensions, namely longitude, latitude, time and an instantaneous speed respectively, that is Pₙ=[xₙ, yₙ, tₙ, vₙ]. For example, the track of a year is divided into 12 sections according to the month, namely 12 graphs.

Step S2) in which the track compression algorithm is employed specifically includes:

In practice, track compression may generally employ methods such as time interval point selection, distance spacing point selection or speed-based point selection, but these methods may lose some key data. In order to better retain basic features and reduce algorithm complexity as much as possible, the present application employs a classical Douglas-Peucker track compression algorithm. The algorithm can extract some prominent points from the original dense points, and the track connected by these points is roughly similar to an original track outline, so as to realize the function of replacing the original track.

In order to input the tracks of the trucks into the track embedding model for training, the spatiotemporal track sequence T needs to be transformed into a graph G, G=(V,E), where V represents a set of nodes, and E represents a set of edges. The method to determine the set V of nodes is to cluster track points on the whole track, and regard a cluster of points as a node. However, due to a high collection frequency and a large sample size of the GPS data of the trucks, in order to improve the operation efficiency of the algorithm, the points on the track can be thinned first by using the track compression method, and then, the nodes can be determined by the clustering method.

In the present application, for the track T=[P₁, P₂, . . . , Pₙ, . . . , P_{N}], track compression includes the following steps:

(1) Defining variables and parameters: set a distance threshold D, defining a compressed track set C, and adding two endpoints P₁ and Pₙ of the track into the set C.

(2) Finding a point of division: traversing all points in the track T to find the point P_{c} farthest from the line segment P₁Pₙ and the maximum distance d, and if d> D, adding P_{c} into the set C.

(3) Performing a recursive loop: dividing the original track into two segments by a point P_{c}, taking P_{c} as an endpoint, and enabling the two segments of tracks to repeat step (2) until the maximum distance d in all sub-tracks is less than the distance threshold D.

By means of the above steps, the compressed track set C of the track T can be obtained, and a compression rate depends on a parameter distance threshold D. The smaller D is, the more original data is retained. The larger D is, the smaller the compressed point set is, but a distortion rate will also be increased. It is necessary to adjust the parameters according to the actual situation and compress the data amount on the basis of retaining the features of the original data as much as possible.

In step S3), a clustering algorithm is employed.

After the tracks are compressed, in order to form a graph suitable for being input into a deep learning model, tracks points need to be further clustered. Since the track points have obvious shape features and low dimensionality, the clustering algorithm of DBSCAN is selected in the present application. Such a clustering algorithm is a density-based clustering algorithm, which can recognize high-density regions with arbitrary shapes, has good anti-interference performance, and has a very significant effect on track data processing.

In the present application, for the track C=[P₁, P₂, . . . , Pₘ> . . . , P_{M}] (M represents the total number of sampling points after track compression), the steps of track clustering are as follows:

(1) Setting parameters: k is set as the minimum number of points in a neighborhood, and r is set as a neighborhood radius.

(2) Creating a group: randomly selecting a point Pₘ, if other points exist in the neighborhood radius r of Pₘ and the number is greater than k−1, creating a new group A and classify Pₘ into the group, otherwise classifying Pₘ as a noise point, and reselecting points.

(3) Expanding the group: traversing all points in the neighborhood of Pₘ, if other points exist in the neighborhood radius r and the number is greater than k−1, classifying same into a new group A, and continuing performing recursion by using this method until no point that satisfies the requirements exists in the neighborhood.

(4) Performing cyclic grouping: randomly selecting points again, and repeating the above process until all the points have groups to which theses points belong or are recognized as noise points.

Since this method can recognize a region with a relatively high density, all the sub-tracks belonging to the same region may be classified into a cluster. The cluster is denoted as a node, and a node set is V. A vehicle moves between different sub-tracks, which is recorded into an edge set E of the graph, where the edge is a directed edge. Moreover, the degree of the node may be calculated, thereby forming a network graph G representing the whole motion track.

### Track Embedding Model:

Since there is the problem of low operation when the graph is directly used for computing, in order to compare the similarity between track graphs, a graph embedding model need to be employed. The graph is mapped into a vector with one dimension k, and k is much smaller than the number of nodes in the original graph, such that the next research can analyze the graph in the form of low-dimensional vector by using machine learning, deep learning and other methods.

The present application employs a graph2vec algorithm, which is an unsupervised learning representation method based on a graph kernel. By means of training of a neural network, the whole track graph is embedded, and explicit embedding vectors that can be used for similarity calculation are obtained. The algorithm employs a document embedding method in natural language processing for reference in thinking. Compared with doc2vec, graph2vec regards the whole graph as a document, and the rooted subgraph extracted from the graph as a word. The form in which the rooted subgraph forms the subgraph can be regarded as the form in which words form a sentence or paragraph. The basic process for the graph2vec algorithm is as follows: firstly, extract a rooted subgraph of each node from the whole graph, then, perform vector embedding by using a Skipgram model, and finally, optimize an output result by using a stochastic gradient descent (SGD) algorithm.

The specific steps are as follows:

### Extraction of Rooted Subgraph

The rooted subgraph is a subgraph with a certain node in the graph as a root node and a maximum depth as a specified parameter D. The rooted subgraph is a high-order substructure that can better retain the structural features of the original graph than a low-order or linear substructure. The steps for extracting the rooted subgraph are as follows:

(1) Determining a parameter: determining the maximum depth D of the rooted subgraph.

(2) Searching a node: finding a neighbor node of a node RN from each depth dx from 0 to D by employing a breadth-first algorithm, then, searching all subgraphs with the depth of dx-1 for each neighbor node, and recording same in the set M_{z}^{(dx)}, and finding a subgraph with the node RN as a root node and the depth of dx-1.

(3) Performing reordering and merging: relabeling the subgraphs in M_{z}^{(dx)} by using a Weisfeiler-Lehman algorithm, and then, performing merging with M′ into a subgraph with the depth of dx as an output.

Through the above steps, the rooted subgraphs of all the nodes in the graph are obtained, and unique labels are assigned to all the subgraphs.

### Skipgram Model for Negative Sampling

The Skipgram model is a feedforward neural network model. In the gragh2vec algorithm, the function of the model is to predict possible subgraphs before and after a given subgraph, that is, to calculate the maximum likelihood estimation. For example, T subgraphs of the whole graph are given: {ω₁, ω₂, . . . , ωₜ, . . . , ω_{T}}, a window length is determined as cw, that is, the subgraph to be predicted is {_{wt-cw}, . . . , ω_{t+cw}}. In order to maximize the prediction probability, the maximum likelihood estimation method is employed, and the calculation method is shown in Formula (1).

$$R ( {d}_{i} ) = {\sum }_{t = 1}^{T} log Pr ( {ω}_{t - cw} , … , {ω}_{t + cw} \vert {ω}_{t} ) \qquad ( 1 )$$

In the formula, Pr(ω_{t-cw}, . . . , ω_{t+cw}|ωₜ) represents the product of the probability of occurrence of each subgraph in the case of occurrence of ωₜ, and its calculation formula is Formula (2).

$$Pr ( {ω}_{t - cw} , … , {ω}_{t + cw} \vert {ω}_{t} ) = {\prod }_{- cw \leq j \leq cw , j \neq 0} Pr ( {ω}_{t + j} \vert {ω}_{t} ) \qquad ( 2 )$$

In the formula, Pr(ωₜ₊ⱼ|ωₜ) represents the probability of occurrence of subgraph ωₜ₊ⱼ in the case of occurrence of subgraph ωₜ. Since the probability of occurrence of each subgraph belongs to independent distribution in the set dictionary V of subgraphs, Pr(ωₜ₊ⱼ|ωₜ) may be expressed by Formula (3).

$$Pr ( {ω}_{t + j} \vert {ω}_{t} ) = \frac{exp ( {ω}_{t + j} \cdot {ω}_{t} )}{{\sum }_{w ∈ V} exp ( ω \cdot {ω}_{t} )} \qquad ( 3 )$$

The Skipgram model is a shallow neural network including an input layer, a hidden layer and an output layer. The network graph G to be embedded is selected, and the set of all subgraphs thereof is {ω₁, ω₂, . . . , ωₜ, . . . , ω_{T}}. The window length is determined to be cw, and the subgraph ωₜ is selected in turn as an input of the neural network. The output layer is a softmax regression classifier, each node of which will output a value between 0 and 1, representing the probability distribution of the subgraph set {ω_{t-cw}, . . . , ω_{t+cw}}, and the sum of the probabilities represented by all values is 1. The objective function is maximization of R (d)=Σₜ₌₁^{T} log Pr(ω_{t-cw}, . . . , ω_{t+cw}|ωₜ), where Pr(ω_{t-cw}, . . . , ω_{t+cw}|ωₜ) represents the product of the probability of occurrence of each subgraph in the case of occurrence of subgraph ωₜ, that is Pr(ω_{t-cw}, . . . , ω_{t+cw}|ωₜ)=Π_{-cw≤j≤cw,j≠0} Pr(ωₜ₊ⱼ|ωₜ), where Pr(ωₜ₊ⱼ|ωₜ) represents the probability of occurrence of subgraph ωₜ₊ⱼ in the case of occurrence of subgraph ωₜ, and the calculation formula is Pr(ωₜ₊ⱼ|ωₜ)=exp(ωₜ₊ⱼ·ωₜ)/Σw∈νexp (ω·ωₜ) V is the dictionary composed of all the subgraphs, and the final output of the model is a vector representing the network graph G.

Due to the large amount of thesaurus data composed of all the subgraphs in graph2vec, it is too expensive to directly employ the Skipgram model. The graph2vec algorithm employs a negative sampling training method to reduce the number of elements contained in the dictionary V in the Skipgram model. The specific method is as follows: If the training graph Gᵢ is selected, the subgraph set of Gᵢ is c. A sample set c′ is formed by randomly selecting rooted subgraphs from several groups of graphs adjacent to Gᵢ, where c′⊂V, and c′∩c=ø, which represents an empty set. The number of subgraphs in c′ should be much less than the number of subgraphs in V, and this parameter should be adjusted according to actual needs. Only the sample set c′ needs to be updated for each training. If two graphs are composed of similar rooted subgraphs, embedding results of the two graphs are closer in a vector space.

### Optimization of Output Results

Due to a large sample size, in the algorithm, the stochastic gradient descent method is employed to optimize the output vector. Part of the samples are randomly selected for training to ensure the operation efficiency of the algorithm, and the learning rate α needs to be adjusted according to the actual situation.

For step S5), stability indexes are output.

Whether the tracks in different periods have similarity is determined by means of cosine similarity to analyze the stability of user behavior and recognize abnormal tracks.

All track graphs are jointly combined into a vector space, and the similarity between two tracks can be compared by calculating the distance between the vectors in this space. There are two ways to measure the distance between the vectors, namely a Euclidean distance and a cosine distance. The cosine distance is more suitable for calculating the similarity between two vectors, that is cos θ=v·u/∥v|×|u∥ the larger the obtained cos θ, the greater the correlation between two tracks. The whole track is divided into several segments according to the time period, and the average value of all the cosine distances is calculated to quantify the stability of the track.

### Embodiment 2

An anomaly recognition system for tracks of trucks is provided in Embodiment 2 of the present disclosure. The system is implemented on the basis of the method in Embodiment 1 and includes: a running track obtainment module, a compression module, a clustering algorithm module, a vector output module and an anomaly recognition module.

The running track obtainment module is used for obtaining a running track T according to GPS data of running of a truck to be recognized.

The compression module is used for employing a track compression algorithm for the running track T to obtain a compressed track set C.

The clustering algorithm module is used for employing a density-based clustering algorithm and performing grouping according to set time periods to obtain a network graph G representing a motion track of each time period.

The vector output module is used for inputting the network graph G into a track embedding model established and trained in advance to obtain an explicit embedding vector corresponding to each network graph.

The anomaly recognition module is used for determining stability according to a distance between the vectors, and classifying points with the stability lower than a set threshold as abnormal tracks.

The track embedding model is realized by employing a Skipgram model on the basis of a graph2vec algorithm.

### Experimental Results

1. The GPS track data of 206 trucks are included in the data set selected for this experiment. The track data of each truck is composed of 100 thousand track points.

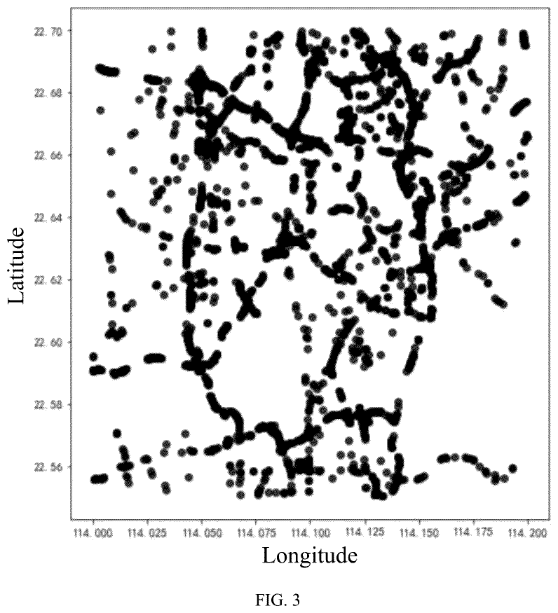

2. For the effect of track compression, the original track is shown in FIG. 2, and the track after track compression is shown in FIG. 3.

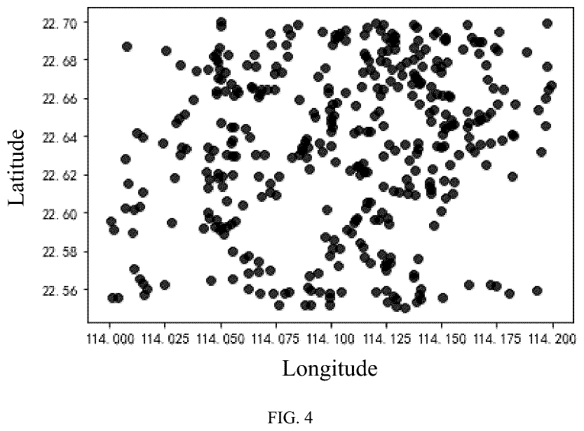

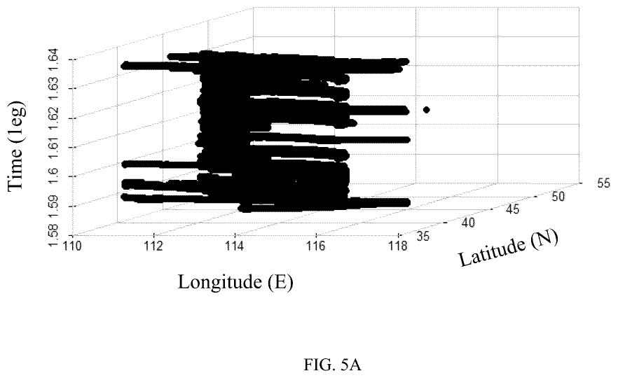

3. The tracks are grouped by month, and then, each group of tracks are clustered. The effect of one group is shown in FIG. 4, and each point represents the cluster center after clustering. Vector embedding is performed on the processed tracks, and each graph is represented as a 128-dimensional vector.

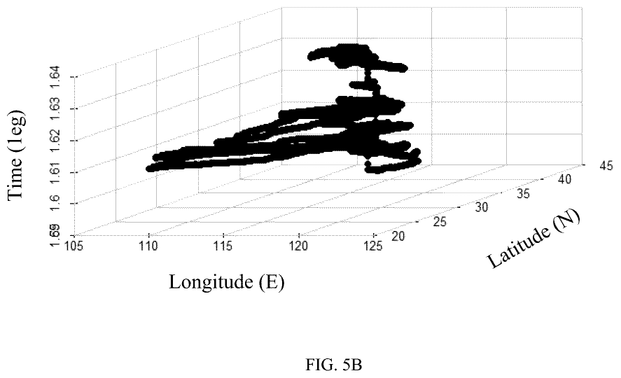

4. Cosine similarity is obtained by means calculation to express the quantitative stability index of each vehicle, and a stability threshold is set by comparing a visualization track diagram. Effects are shown in FIG. 5A and FIG. 5B. The stability index of the user is higher than the threshold, as shown in FIG. 5A, and the stability index is lower than the threshold, as shown in FIG. 5B, which is determined to be abnormal. The three-dimensional coordinates in the diagrams represent longitude, latitude, and time respectively. Each point represents the geographical position of the vehicle at a certain time, where time is based on the product of seconds at 8 o'clock on Jan. 1, 1970, in units of 1e9, representing the ninth power of 10 in scientific notation.

5. To test the experimental effect, a self-similarity test is employed. The track sequence of a certain user is divided into two sub-sequences according to the parity of row number, and similarity of embedding vectors of the two sub-sequences is compared. If the similarity is high, the model is valid. In this experiment, 20 users are randomly selected for the experiment, 13 of these users have self-similarity being over 0.95, and the rest are over 0.8, which is much higher than the stability threshold. Therefore, it can be proved that the model is effective in quantifying the stability of user behavior and recognizing abnormal users.

The preferred embodiments of the present application are described in detail above. However, the present application is not limited to specific details of the above embodiments. Within the scope of the technical concept of the present application, various simple modifications may be made to the technical solutions of the present application, and these simple modifications all fall within the protection scope of the present application.

Moreover, it should also be noted that various specific technical features described in the above particular embodiments may be combined in any suitable manner, without contradiction. In order to avoid unnecessary repetition, various possible combination modes are not separately described in the present application.

In addition, various different embodiments of the present application may also be combined randomly, so long as same do not deviate from the idea of the present application, and same should also be regarded as disclosed in the present application.

What is claimed is:

1. An anomaly recognition method for tracks of trucks, comprising:
step S1) obtaining a running track T according to global positioning system (GPS) data of running of a truck to be recognized;
step S2) employing a track compression algorithm for the running track T to obtain a compressed track set C;
step S3) employing a density-based clustering algorithm and performing grouping according to set time periods to obtain a network graph G representing a motion track of each time period;
step S4) inputting the network graph G into a track embedding model established and trained in advance to obtain an explicit embedding vector corresponding to each network graph;
step S5) determining stability according to a distance between the vectors, and classifying points with the stability lower than a set threshold as abnormal tracks;
the track embedding model is realized by employing a Skipgram model on the basis of a graph2vec algorithm;
the running track Tin step S1) satisfies the following formula:
$$T = [ {P}_{1} , {P}_{2} , … , {P}_{n} , … , {P}_{N} ] , \qquad {P}_{n} = [ {x}_{n} , {y}_{n} , {t}_{n} , {v}_{n} ]$$
wherein N represents the total number of points of the motion track, and Pₙ represents data of the nth point, which comprises four dimensions xₙ, yₙ, tₙ, Un, namely longitude, latitude, time and an instantaneous speed respectively;
step S2) specifically comprises:
step S2-1) setting a distance threshold D and a compressed track set C, adding two endpoints P₁ and Pₙ of the track into the set C, and setting a line segment x=P₁Pₙ;
step S2-2) traversing all points between two endpoints of the line segment x to find the point P_{c} farthest from the line segment x and the corresponding maximum distance d, if d> D, adding P_{c} into the set C; otherwise, stopping the cycle, and outputting the compressed track set C;
step S2-3) dividing the original track into two sections by point P_{c}, obtaining two sub-tracks P₁P_{c} and P_{c}Pₙ by taking P_{c} as an endpoint, setting P₁P_{c} and P_{c}Pₙ as the line segment x successively, and going to step S2-2) respectively until the maximum distance din all sub-tracks is less than the distance threshold D to obtain a compressed track set C=[P₁, P₂, . . . , Pₘ> . . . , P_{M}], wherein Pₘ represents the mth sampling point, and M represents the total number of sampling points after track compression;
step S3) specifically comprises:
step S3-1) setting k as the minimum number of points in a neighborhood and r as a neighborhood radius;
step S3-2) randomly selecting a point Pₘ in the track set C, if other points exist in the neighborhood radius r of Pₘ and the number is greater than k−1, creating a new group A and classifying Pₘ into the group, otherwise classifying Pₘ as a noise point, and going to step S3-2) to reselect points;
step S3-3) traversing all points in the neighborhood of Pₘ, if other points exist in the neighborhood radius r and the number is greater than k−1, classifying same into a new group A, and going to step S3-3) until no point that satisfies the requirements exists in the neighborhood;
step S3-4) going to step S3-2) to randomly select points again until all the points in the track set C have groups to which theses points belong or are recognized as noise points;
step S3-5) classifying all sub-tracks belonging to the same group into a cluster according to the recognized group, denoting the cluster as a node, wherein a node set is V, a vehicle moves between different sub-tracks, which is recorded into an edge set E of the graph, and the edge is a directed edge; calculating the degree of the node, thereby forming a network graph G representing the motion track of the corresponding time period;
the Skipgram model comprises an input layer, a hidden layer and an output layer, wherein the output layer is a softmax regression classifier, an input of the Skipgram model is a subgraph of each node of a network graph G, and the output is probability distribution of a subgraph set, so as to obtain an embedding vector of the corresponding network graph G;
step S5) specifically comprises:
calculating similarity between the embedding vectors of two adjacent time periods by employing a cosine distance, and calculating an average value of all the cosine distances for quantification to obtain stability of the track; and
classifying points with the stability lower than a set threshold as abnormal tracks.

2. The anomaly recognition method for tracks of trucks according to claim 1, wherein a processing process of the track embedding model in step S4) specifically comprises:
extracting a rooted subgraph of each node from the network graph G, performing vector embedding by using the Skipgram model, and optimizing an output result by using a stochastic gradient descent algorithm.

3. The anomaly recognition method for tracks of trucks according to claim 2, wherein the extracting a rooted subgraph of each node from the network graph G specifically comprises:
determining the maximum depth Dh of the rooted subgraph;
finding a neighbor node of a certain node RN from each depth dx from 0 to Dh by employing a breadth-first algorithm, then, searching all subgraphs with the depth of dx−1 for each neighbor node, recording same in the set M_{z}^{(dx)}, and then, finding a subgraph M′ with the node RN as a root node and the depth of dx−1, wherein the subscript z represents the zth node;
relabeling the subgraphs in M_{z}^{(dx)} by using a Weisfeiler-Lehman algorithm, and then, performing merging with M′ into a subgraph with the depth of dx as an output; and
repeating the above steps until subgraphs of all the nodes are obtained.

4. The anomaly recognition method for tracks of trucks according to claim 1, wherein the method further comprises a training step of the track embedding model, which specifically comprises:
performing training in a negative sampling manner, selecting a training graph Gᵢ to be trained, wherein a subgraph set of Gᵢ is c; performing randomly selection from several groups of graphs adjacent to Gᵢ to form a sample set c′ by selecting root subgraphs of these graphs, such that c′∩c=Ø, and only the sample set c′ is updated in each training; and performing training according to a set learning rate α until training requirements are satisfied, thereby obtaining a trained track embedding model, wherein Ø represents an empty set.

5. A recognition system based on the anomaly recognition method for tracks of trucks according to claim 1, comprising: a running track obtainment module, a compression module, a clustering algorithm module, a vector output module and an anomaly recognition module, wherein
the running track obtainment module is used for obtaining a running track T according to GPS data of running of a truck to be recognized;
the compression module is used for employing a track compression algorithm for the running track T to obtain a compressed track set C;
the clustering algorithm module is used for employing a density-based clustering algorithm and performing grouping according to set time periods to obtain a network graph G representing a motion track of each time period;
the vector output module is used for inputting the network graph G into a track embedding model established and trained in advance to obtain an explicit embedding vector corresponding to each network graph;
the anomaly recognition module is used for determining stability according to a distance between the vectors, and classifying points with the stability lower than a set threshold as abnormal tracks; and
the track embedding model is realized by employing a Skipgram model on the basis of a graph2vec algorithm.
